(19) United States
(12) Patent Application Publication
(10) Pub. No.: US 2008/0292111 A1
(43) Pub. Date: Nov. 27, 2008

(54) Headset for Blocking Noise

(75) Inventor: Sung Kyun Park, Seoul (KR)

Correspondence Address: MERCHANT & GOULD PC, P.O. BOX 2903, MINNEAPOLIS, MN, 55402-0903, US

(73) Assignee: COMTECH, INC., Anseong-si, Geonggi-so (KR)

(21) Appl. No.: 11/722,314

(22) PCT Filed: Dec. 21, 2005
(86) PCT No.: PCT/KR05/04421

§ 371 Date: Jan. 16, 2008

(30) Foreign Application Priority Data
Dec. 22, 2004 (KR) 10-2004-0110382

(51) Int. Cl. G10K 11/16; H04R 1/10; H04R 5/00

(52) U.S. Cl. 381/71.6; 381/74

(57) ABSTRACT

The present invention relates, in general, to a headset for temporarily blocking or interrupting noise and shock waves above a preset reference level and, more particularly, to a headset for blocking or interrupting noise, which allows a user to listen to typical voices, sounds, etc. through microphones and speakers mounted on the headset, thus allowing the user to normally converse with other users even while wearing the headset, and which senses a noise above the preset reference level which may be generated in places, such as a rifle range, a hunting field, and a large-scale work place and factory where a loud noise is frequently generated, and temporarily blocks or interrupts the output of the speakers, thus preventing auditory organs from being damaged due to noise above the reference level being transmitted through the headset.

### TECHNICAL FIELD

The present invention relates, in general, to a headset for temporarily blocking noise and shock waves above a preset reference level and, more particularly, to a headset for blocking noise, which allows a user to listen to typical voices, sounds, etc. through microphones and speakers mounted on the headset, thus allowing the user to normally converse with other users even while wearing the headset, and which senses a noise above the preset reference level which may be generated in places, such as a rifle range, a hunting field, and a large-scale work place and factory where a loud noise is frequently generated, and temporarily interrupts the output of the speakers, thus preventing auditory organs from being damaged due to noise above the reference level being transmitted through the headset.

### BACKGROUND ART

Generally, a headset includes a pair of speaker housings that have earpads attached thereto and are put on opposite ears, speakers mounted in the speaker housings, respectively, a plug for connecting a music player, such as a two-way radio, an audio player or a MP3 player, to the speakers, and a band adapted to connect the speaker housings and formed to be put on a user's head.

The headset having the above construction has only the function of outputting sounds that are input from external devices using the above plug through the speakers, so that a user cannot hear other users voices or alarm whistles generated in the surroundings except for sounds generated from the external devices. Therefore, there are problems in that the user cannot converse with other persons and cannot easily detect a risk in the surrounding area, such as the approach of a vehicle when wearing the headset.

In order to solve the problems, a headset has been used in which microphones are mounted on existing speaker housings and surrounding voices and sounds, input through the microphones are output through speakers, thus allowing a user to simultaneously listen to sounds generated in a surrounding environment and sounds input from external devices connected to a plug.

However, this headset provided with the microphones is problematic in that, if a noise above a specific reference level is output to the speakers through the microphones without change, a risk of damage to an eardrum increases, and, in particular, it is not suitable for a user to use the headset in a place, such as a rifle range, a hunting field, or a construction site for large-scale work where abrupt loud noises are generated.

Further, in a place, such as a hunting field or rifle range, where loud noises, such as gunshot sounds, are generated intermittently or periodically, a user typically wears earpads to protect his or her eardrums. However, the earpads are problematic in that it makes it difficult for the user to listen to sounds transmitted from surrounding persons and to detect risk factors generated under specific conditions, so that the earpads are not suitable for use in a training camp, a battle field, a hunting field, a rifle range, or a factory in which loud noises are frequently generated.

### DISCLOSURE OF INVENTION

### Technical Solution

Accordingly, the present invention has been made keeping in mind the above problems occurring in the prior art, and an object of the present invention is to provide a headset for blocking noise, in which one or more microphones mounted on speaker housings forming the headset, an input noise sensing means for sensing the level of sound input from the microphones, and a speaker output control means for determining whether to operate speakers according to the level of noise sensed by the input noise sensing means, are installed, so that voices, sounds, etc. generated in a surrounding environment can be sensed in a normal state, and the output of the speakers is temporarily interrupted when a noise above a specific reference level is generated, thus preventing auditory organs from being damaged.

Another object of the present invention is to provide a headset for blocking noise, in which external device connection terminals connected to the speakers are mounted on the speaker housings to allow the headset to be connected to a music player, a two-way radio, a mobile phone, etc., so that the user can listen to both the sounds generated in a surrounding environment and sounds generated from external devices, such as the two-way radio, even in a place, such as a hunting field, a rifle range, a military training camp or a battle field, thus widening the utilization range of the headset.

A further object of the present invention is to provide a headset for blocking noise, in which a volume controller (an indoor-outdoor function switch) is further mounted on the speaker housings, so that the levels of input sound and noise to be blocked can be set variously in consideration of surrounding conditions.

Yet another object of the present invention is to provide a headset for blocking noise, in which ring-shaped earpads are mounted on portions of the speaker housings coming into contact with the ears, and implemented to have gel-type material therein and slits formed in center portions to entirely cover the user s ears and allow the user to comfortably wear the headset, thus increasing the efficiency of the headset.

In order to accomplish the above objects, the present invention provides a headset for blocking noise, the headset including speaker housings having speakers therein, comprising one or more microphones mounted on the speaker housings; input noise sensing means placed between the microphones and the speakers to sense sound input from the microphones; and speaker output control means for interrupting output of the speakers when a level of the sound sensed by the input noise sensing means is greater than or equal to a preset reference level.

### ADVANTAGEOUS EFFECTS

As described above, the present invention provides a headset for blocking noise, which allows a user to listen to typical sounds generated in a surrounding environment by controlling the level of the sounds, and temporarily interrupts noise above a reference level when the noise is generated, thus safely protecting the user's auditory organs.

Further, the present invention is advantageous in that, when a loud noise is temporarily blocked, the time during which the noise is blocked is set to a short period, so that the interruption of conversation, listening to music, wireless communication, etc. is minimized, thus preventing difficulty in using the headset, and preventing interference from occurring when conducting training, strategic moves or work in a hunting field, a rifle range, a military training camp, a battle field or a work place in which large-scale work is performed.

Further, the present invention is advantageous in that a volume controller is additionally mounted on a speaker housing to provide separate function modes to use the headset indoors or outdoors, and the levels of input sound and noise to be blocked can be suitably set to meet these environments, thus increasing the efficiency of the headset.

Moreover, the present invention is advantageous in that earpads, in which gel-type material is included in portions of the speaker housings coming into contact with ears, and in which one or more cut parts are formed on the outward faces of the earpads, are installed on the headset, so that the user's ears can be fully covered regardless of wearing position, and difficulty caused by the wearing of the headset can be minimized even when the user wears the headset for a long period of time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### BRIEF DESCRIPTION OF THE DRAWINGS

FIG. 1 is a block diagram showing the construction of a headset for blocking noise according to an embodiment of the present invention;

FIG. 2 is a block diagram showing the construction of a headset for blocking noise according to another embodiment of the present invention and

FIG. 3 is a perspective view showing the external shape of a headset for blocking noise according to an embodiment of the present invention.

100, 200: speaker housings
110, 210: speakers
120, 260: external device connection terminals
130, 220: microphones
140: input noise sensing means
150: speaker output control means
202: earpad
204: band
206: Light Emitting Diode
230: pre-amplifier
240: electronic volume
250: volume controller
270: amplifier
280: peak level detector
290: amplifier controller

### BEST MODE FOR CARRYING OUT THE INVENTION

Hereinafter, embodiments of the present invention will be described in detail with reference to the attached drawings.

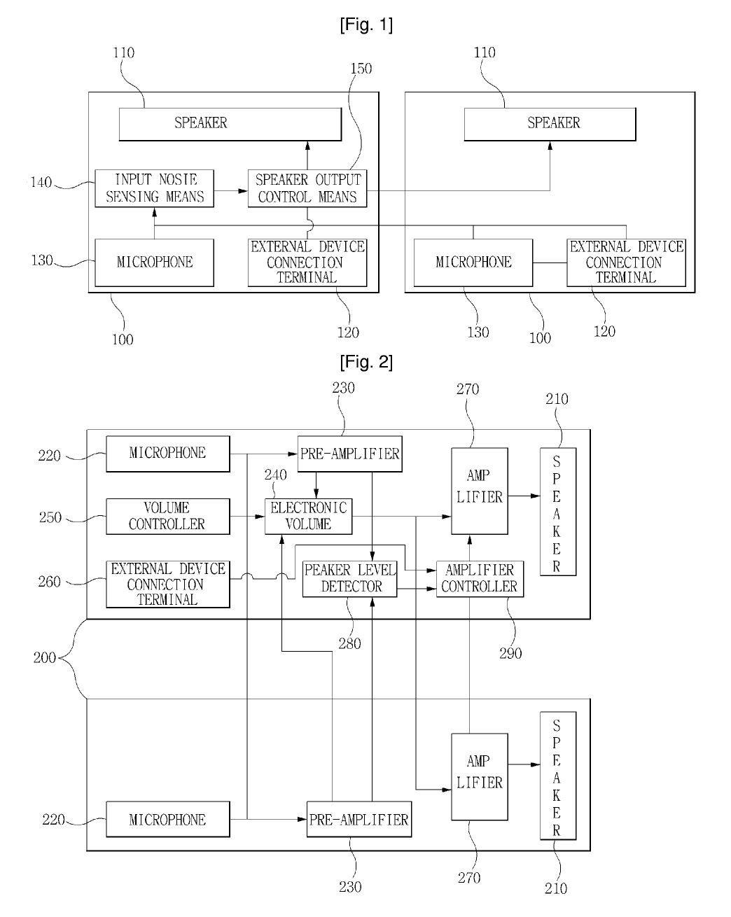

FIG. 1 is a block diagram showing the construction of a headset for blocking or interrupting noise according to an embodiment of the present invention. The headset of the present invention includes speaker housings 100 forming the headset; speakers 110 mounted inside of a pair of the speaker housings 100; external device connection terminals 120 for connecting the speakers 110 to an external device, such as a music player, a two-way radio or a mobile phone; one or more microphones 130 mounted on the speaker housings 100 to sense surrounding sound; an input noise sensing means 140 for sensing the level of the surrounding sound input through the microphones 130; and a speaker output control means 150 for interrupting the output of the speakers 110 when the level of the sound sensed by the input noise sensing means 140 is equal to or greater than a preset reference level.

The headset having the above construction is operated in such a way that a user listens to sounds input from a music player, a two-way radio, a mobile phone, etc. through the external device connection terminals 120, a sound less than the preset reference level, among the sounds input through the microphones 130, is output through the speakers 110 to allow the user to listen to the sound, and the speaker output control means 150 is operated to temporarily interrupt the output of the speaker 110 when a noise above the reference level is generated, thus preventing the user from hearing the noise.

For the operation of the input noise sensing means 140, a peak level detector for detecting the level of a peak of an electrical signal of the sound input from the microphones 130 can be used. For the speaker output control means 150, an electrical switch can be used. Further, the headset of the present invention may include a power supply means for operating components of the headset such as the microphones 130, the input noise sensing means 140, and the speaker output control means 150. Further, the headset of the present invention may include an indoor-outdoor function switch to arbitrarily set and use the level of input sound or noise to be blocked depending on a place by classifying the function modes of the headset into an indoor function and an outdoor function.

Further, the reference level of noise, sensed by the input noise sensing means 140 and used to interrupt the output of the speakers 110, is about 70 to 100 dB, and the time during which the output of the speakers 110 is interrupted is about 0.02 to 2.0 seconds, thus minimizing the interruption of typical conversation or sounds of external devices.

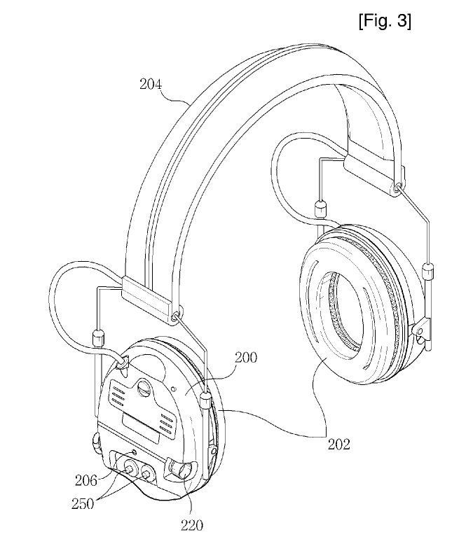

FIG. 2 is a block diagram showing the construction of a headset for blocking noise according to another embodiment of the present invention. The headset of the present invention includes speakers 210 and microphones 220 mounted on a pair of speaker housings 200, respectively, as shown in FIG. 2. Further, the headset includes pre-amplifiers 230 placed between the speakers 210 and the microphones 220 to convert surrounding sounds, input from the microphones 220, into electrical signals; an electronic volume 240 used to control the level of the electrical signals output from the pre-amplifiers 230; a volume controller 250 used to set the level of the electronic volume 240; an external device connection terminal 260 connected to the pre-amplifiers 230; amplifiers 270 for amplifying the electrical signals controlled by the electronic volume 240 and outputting the amplified signals through the speaker 210; a peak level detector 280 for detecting the peak level of the electrical signals converted by the pre-amplifiers 230; and an amplifier controller 290 for controlling the amplifiers 270 to interrupt the output of the speakers 210 when the peak level of the signals detected by the peak level detector 280 is equal to or greater than a reference level. In this case, the headset may include a power supply means (not shown) mounted in the speaker housings 200 to supply power required to operate the above components.

If the level of sound output through the speakers 210 is controlled using the volume controller 250 after the user wears the headset having the above construction and covers his or her ears with the headset, the headset is driven by the following method. First, if sound is input through the microphones 220 on the outer circumferences of the speaker housings 200, the pre-amplifiers 230 are driven. At this time, if the volume controller 250 is controlled, the electronic volume 240 within the speaker housings 200 is operated, and the volume of the sound input to the headset through the microphones 220 is controlled according to the user's control. The sound having the volume, controlled by the electronic volume 240 in this way, is amplified by the amplifiers 270, and the amplified electrical signal is transmitted to auditory organs through the speakers 210, thus allowing the user to sense voices, sounds, etc.

If a sound above the preset reference level, that is, a noise, is generated while surrounding sound is input through the microphones 220, the pre-amplifiers 230 convert the sound into an electrical signal. Then, if the peak level detector 280 detects a peak level equal to or greater than the preset reference level from the electrical signal, the amplifier controller 290 for controlling the amplifiers 270 depending on the peak level is operated and then temporarily interrupts the output of the speakers 210. After a certain period of time has elapsed, the operation of the amplifiers 270 resumes, so that external sound is output through the speakers 210. At this time, the reference level of noise allowing the amplifiers 270 to be controlled can be set to about 70 to 100 dB, and preferably set to about 80 to 90 dB. Further, when a noise above the preset reference level is detected, a time during which the output of the speaker is interrupted by operating the amplifier controller 290 can be set to about 0.02 to 2.0 seconds. Most preferably, the time can be set to about 0.8 to 1.3 seconds for the indoor function and about 0.2 to 0.6 seconds for the outdoor function, thus preventing interference from occurring in conversation, listening to music, wireless communication, etc.

FIG. 3 is a perspective view showing the external shape of a headset for blocking noise according to an embodiment of the present invention. The headset of the present invention includes a pair of speaker housings 200; earpads 202 mounted on the outer portions of the inward faces of the speaker housings 200 to bring the speaker housings 200 into close contact with a user s ears; microphones 220 formed on portions of the speaker housings 200 to receive surrounding sounds; a volume controller 250 formed on another portion of any one of the speaker housings 200 to control the volume of sounds according to a surrounding environment; an external device connection terminal 220 mounted on the other portion of any one of the speaker housings 200 to connect an external device, such as a music player, a two-way radio or a mobile phone, to the headset; and a band 204 for connecting the pair of speaker housings 200 to be put on the user's head.

In order to control the indoor or outdoor functions of the headset, the volume controller 250 mounted on a portion of the outer circumference of any one of the speaker 200 housings can be constructed in the form of a switch so that, if the switch is pressed once, the switch has an indoor function, while if the switch is pressed again, the switch has an outdoor function. Further, a Light Emitting Diode (LED) 206 may be installed around the volume controller 250 to easily indicate whether the headset is currently being used for the indoor function or outdoor function. For example, the LED 206 can be implemented to indicate whether the headset is currently being used for the indoor or outdoor function depending on the ON/OFF state of the LED 206.

Further, each of the earpads 202 is constructed so that soft material or gel-type material is put in a soft pouch and is formed in a ring shape to have a certain width, and the ring-shaped material is attached to the outer portion of the inward face of each of the speaker housings 200. Further, one or more cut parts are formed on the outward faces of the earpads 202, so that the shape of the earpads 202 can be modified according to a wearing method, thus enabling the earpads to come into close contact with ears regardless of wearing position, and minimizing inconvenience even if the headset is used for a long period of time.

### INDUSTRIAL APPLICABILITY

The headset of the present invention is used when conducting training, strategic moves or work in a hunting field, a rifle range, a military training camp, a battle field or a work place in which large-scale work is performed.

1. A headset for blocking noise, the headset including speaker housings 100 having speakers 110 therein, comprising: one or more microphones 130 mounted on the speaker housings 100; input noise sensing means 140 placed between the microphones 130 and the speakers 110 to sense sound input from the microphones 130; and speaker output control means 150 for interrupting output of the speakers 110 when a level of the sound sensed by the input noise sensing means 140 is greater than or equal to a preset reference level.

2. The headset according to claim 1, further comprising a volume controller for setting the level of the sound input from the microphones 130.

3. The headset according to claim 2, wherein the volume controller is a switch for changing a volume of sound to a volume for indoor function or a volume for outdoor function.

4. The headset according to claim 1, further comprising power supply means installed to operate components of the headset, such as the microphones 130, the input noise sensing means 140 and the speaker output control means 150.

5. The headset according to claim 1, further comprising at least one external device connection terminal 120 for outputting sounds from an external device to the speakers 110.

6. The headset according to claim 1, wherein the input noise sensing means 140 is a peak level detector for detecting a peak level of an electrical signal converted by the microphones 130.

7. The headset according to claim 1, wherein the reference level of sound allowing the output of the speakers 110 to be controlled according to the level of the sound sensed by the input noise sensing means 140 is about 70 to 100 dB.

8. The headset according to claim 1, wherein the speakers 110 are implemented so that output thereof is interrupted for a time of about 0.02 to 2.0 seconds when the sound above the reference level is generated.

9. A headset for blocking noise, the headset including speaker housings 200 having speakers 210 therein, comprising: one or more microphones 220 mounted on the speaker housings 200; a pre-amplifier 230 for converting surrounding sound, input from the microphones 220, into an electrical signal; an electronic volume 240 for controlling a level of the electrical signal output from the pre-amplifier 230; an amplifier 270 for amplifying the electrical signal, the level of which has been controlled by the electronic volume 240, and outputting the amplified signal to the speakers 210; a peak level detector 280 for detecting a peak level of the electrical signal converted by the pre-amplifier 230 and an amplifier controller 290 for controlling the amplifier 270 to interrupt output of the speakers 210 when a peak level of the signal detected by the peak level detector 280 is greater than or equal to a reference level.

10. The headset according to claim 9, further comprising a volume controller 250 for setting a level of the electronic volume 240.

11. The headset according to claim 10, wherein the volume controller 250 is a switch for changing a volume of sound to a volume for indoor function or a volume for outdoor function.

12. The headset according to claim 9, further comprising at least one external device connection terminal 260 connected to an external device, such as an external sound generation device.

13. The headset according to claim 9, wherein the reference level of sound allowing the amplifier controller to be operated according to a level of sound sensed by the peak level detector 280 is about 70 to 100 dB.

14. The headset according to claim 9, wherein the amplifier 270 is implemented so that an operation thereof is interrupted for 0.02 to 2.0 seconds when a noise above the reference level is generated.

15. The headset according to claim 9, further comprising power supply means installed to operate above-described components.

16. A headset for blocking noise, the headset including speaker housings 200 having speakers 210 therein, comprising: one or more earpads 202 attached to outer portions of inward faces of the speaker housings 200, made of soft material contained in soft pouch, and provided with cut parts formed on outward faces of the earpads.
